(19) United States
(12) Patent Application Publication
(10) Pub. No.: US 2012/0215358 A1
(43) Pub. Date: Aug. 23, 2012

(54) ROBOTIC ARM SYSTEM

(75) Inventors: Nathan D. GETTINGS, Palo Alto, CA (US); Adam M. GETTINGS, Palo Alto, CA (US); Taylor J. PENN, Palo Alto, CA (US); Gwynn MASADA, Portola Valley, CA (US); Alexander JASSO, Portland, OR (US); Daniel BLAUGRUND, Vancouver (CA); Kenneth SPROTT, Davis, CA (US); Isreal BLAGDAN, Oakland, CA (US); Ken HAVEN, Livermore, CA (US)

(73) Assignee: RoboteX Inc., Palo Alto, CA (US)

(21) Appl. No.: 13/363,199

(22) Filed: Jan. 31, 2012

Related U.S. Application Data
(60) Provisional application No. 61/438,168, filed on Jan. 31, 2011.

(51) Int. Cl. B25J 13/08; B25J 5/00; G06F 19/00; B25J 18/00; B25J 15/00

(52) U.S. Cl. 700/259; 74/490.01; 294/213; 700/245; 901/1

(57) ABSTRACT

A robotic arm for use with a robotic system and methods for making and using the same are described. The arm can have multiple joints and can have one or more articulating end effectors. The arm and end effectors can have safety releases to prevent over-rotation. The arm can have individual cooling.

### CROSS-REFERENCE TO RELATED APPLICATIONS

The present application claims priority to U.S. Provisional Application 61/438,168 filed 31 Jan. 2011 which is incorporated by reference herein in its entirety.

### TECHNICAL FIELD

This invention relates generally to the robotics field, and more specifically to a new and useful robotic arm system.

### BACKGROUND

Robot systems can be used in security situations, industrial settings, and for entertainment. The robot systems can provide audio and video information to a remote operator in dangerous situations such as bomb defusing, chemical spills, SWAT missions, and search and rescue operations. However, if an operator of a robot system encounters a situation requiring delicate manipulation of objects, for example examining an object or taking a chemical sample, it is difficult to accomplish. Thus, there is a need in the robotics field to create a new and useful robotic arm system.

### SUMMARY OF THE INVENTION

A robot system is disclosed. The system can have a mobile robot and a robotic arm system attached to the mobile robot. The robotic arm system can have an arm base, an arm, a gripper attached to the arm at an end effector attachment location, and a gripper override mechanism. The gripper override mechanism can have a sensor and a clutch. The clutch can have a linear slip interface.

The system can have a captive fastener attaching the arm base to the mobile robot. The captive fastener can have a thumbscrew attached to the arm base.

The system can have a motor and a gearbox. The gearbox can have a non-backdriveable, right-angle high-torque gearbox. The gearbox can have two stages of gears. The gearbox can have a first planetary gear attached to a motor, a right angle worm gear attached to the planetary gear at the motor, and a second planetary gear attached to the right angle worm gear.

The gripper can be detachably attached to the robotic arm system at the end effector attachment location. The system can have a poker configured to be detachably attached to the robotic arm system at the end effector attachment location. The system can have a blower configured to be detachably attached to the robotic arm system at the end effector attachment location.

The arm can have a payload interface. A camera connector can be attached to the payload interface. The arm can have a payload interface. An arm extension can be attached to the payload interface.

The arm can have a payload interface. A second gripper can be attached to the payload interface.

The robot can have a chassis. The arm base can have a base alignment feature. The base alignment feature can mate with a chasses alignment feature in the chassis of the robot.

The system can have an expandable data bus comprising a node. The system can have at least one motor controller connected to the expandable data bus. The system can have a peripheral connected to the expandable data bus. The peripheral connected to the expandable data bus can be a camera.

A robot system is disclosed that can have a mobile robot and a robotic arm system attached to the robot. The robotic arm system can have an arm base, an arm, a motor configured to drive motion of the arm, and a gearbox. The gearbox can have a non-backdriveable, right-angle high-torque gearbox.

A robot system is disclosed that can have a mobile robot, and a robotic arm system attached to the robot. The robotic arm system can have an arm base, a gripper, and a cooling device that can have a fan.

A robot system is disclosed that can have a mobile robot and a robotic arm system attached to the robot. The robotic arm system can have an arm base, a first arm, a first camera attached to the first arm, a second arm extending from the first arm, and a second camera attached to the second arm. The system can have a first light attached to the first arm and a second light attached to the second arm.

### BRIEF DESCRIPTION OF THE FIGURES

FIG. 1 is a schematic representation of a variation of the robotic arm system.

FIGS. 2-4 are perspective drawings of a variation of the robotic arm system.

FIG. 5 is a top perspective view of a variation of a mobile robot with the robotic arm system.

FIG. 6 is a perspective view of a variation of the robotic arm system.

FIG. 7 is a schematic representation of a drive component of a variation of the invention.

FIGS. 8 is a perspective, partial see-through view of a variation of the robotic arm system.

FIG. 9 is a close-up view of a portion of FIG. 8.

FIGS. 10-16 are exploded views of various components of variations of the robotic arm system.

FIG. 17 is an electrical schematic diagram of various components of a variation of the robotic arm system.

FIG. 18 is a close-up, cut-away, partially see-through perspective view of a variation of the robotic arm system.

FIG. 19 is a close-up, partially see-through view of a portion of FIG. 18.

FIG. 20 illustrates a component of a variation of the robotic arm system.

FIGS. 21-23 illustrate a variation of the mounting and attaching elements for a variation of the robotic arm system.

FIG. 24 is a perspective drawing of a variation of the robotic arm system.

FIG. 25 is a cut away perspective drawing of a variation of the robotic arm system.

FIG. 26 is an exploded perspective drawing of a component of a variation of the robotic arm system.

FIG. 27 is a variation of section 300 of FIG. 24.

FIG. 28 is a cut away drawing of an alternative joint structure for elbow joints, shoulder joints and wrist joints on the robotic arm system.

FIG. 29 is a partial cut-away view of a variation of the gearbox.

### DETAILED DESCRIPTION

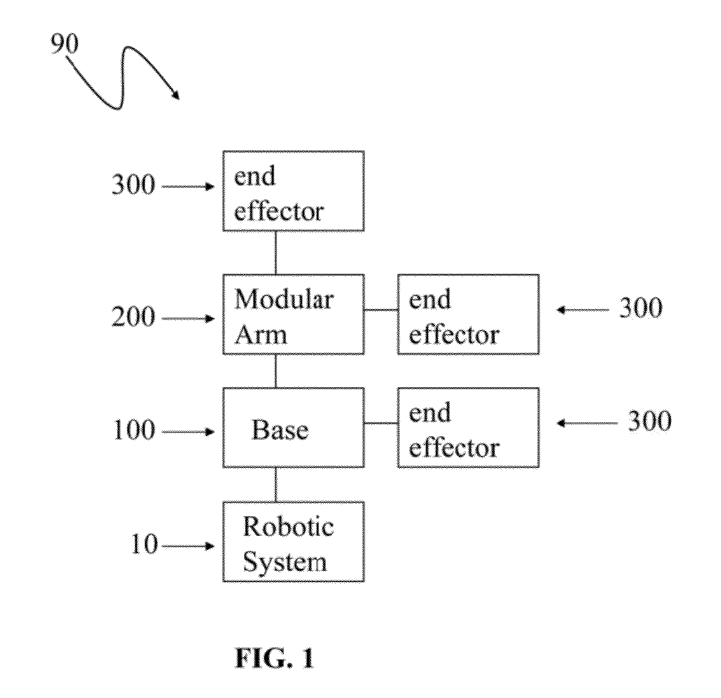

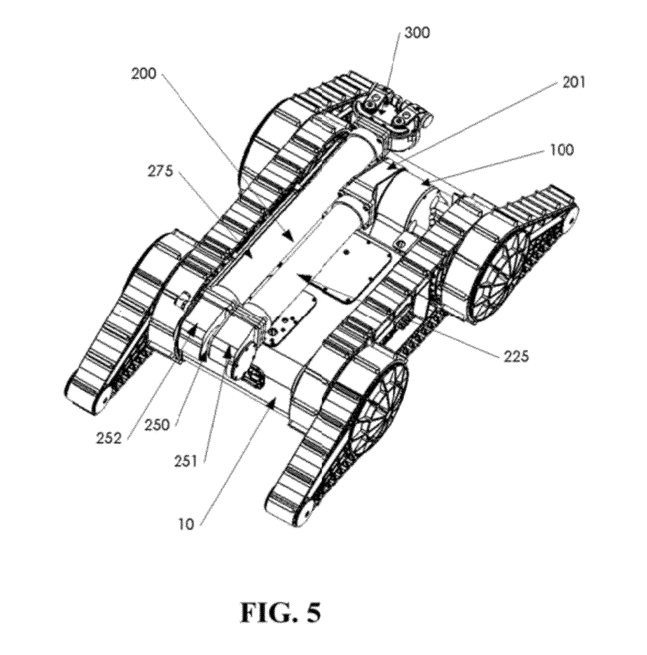

The robotic arm system 90 can be attached to and be a component of a robotic system 10. As shown in FIGS. 1-5, the robotic arm system 90 can include a base 100, at least one modular arm 200, and at least one end effector 300.

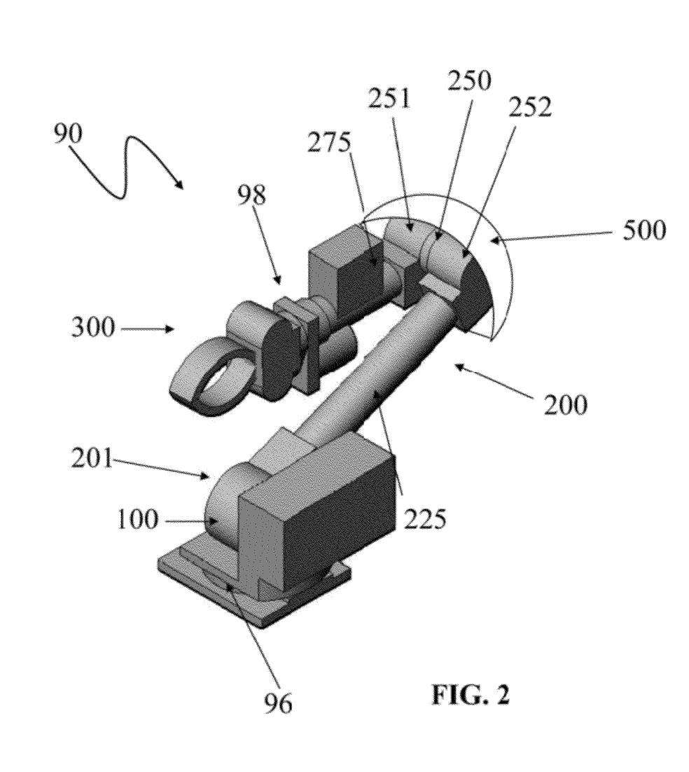

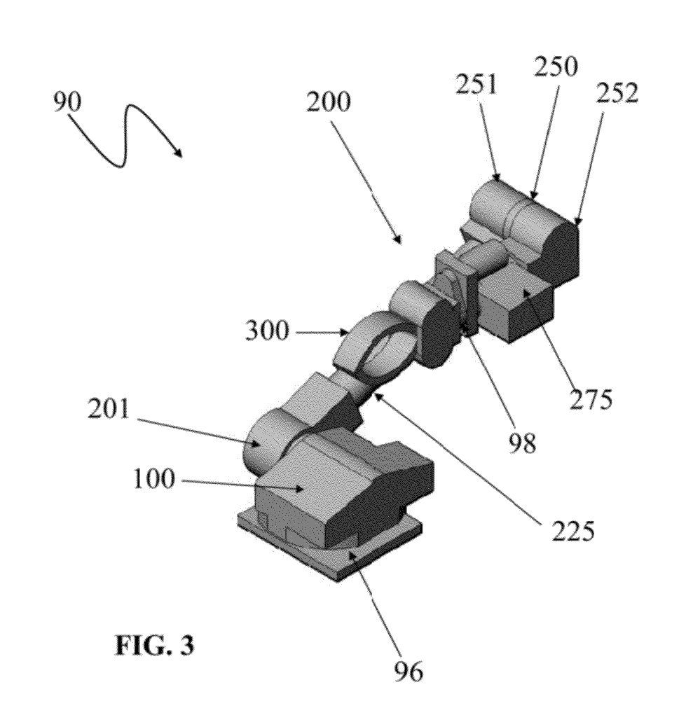

As shown in FIGS. 2-4, the robotic arm system 90 can be constructed in a variety of configurations, depending on the characteristics of the robotic system 10. As shown in FIG. 2, the robotic arm system 90 can fold down into a low profile, enabling a robotic system 10 to have a low clearance. As shown in FIG. 3, the end effector 300 can be nested behind the base 100, for example, to enable the end effector 300 to perform additional functionality, for example using a camera to capture images, while the arm is in a stored position.

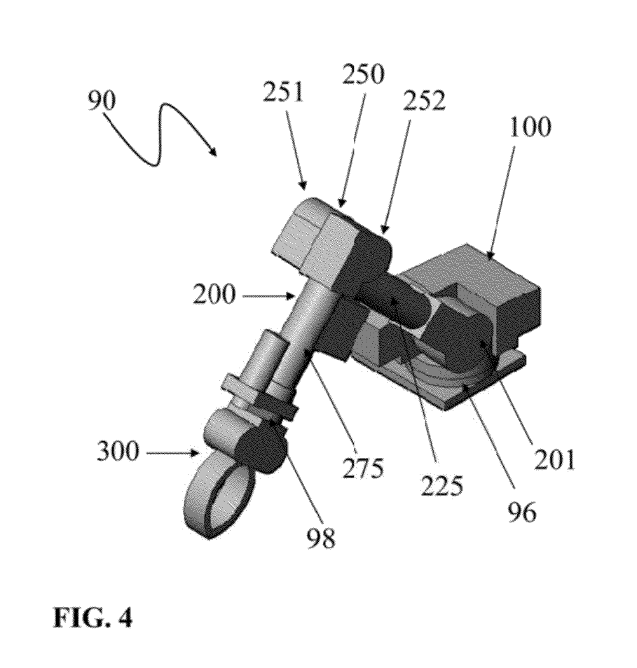

As shown in FIG. 4, the shoulder joint can be located behind the base 100. The shoulder joint can narrow the profile of the modular arm 200, for example to add an additional modular arm extension component to the robotic arm system 90. The robotic arm system 90 can have multiple motor systems controlling stages of the modular arm 200. The robotic arm system 90 can be used to press against the ground or a stationary and anchored object to flip the robotic system 10, such as when the robotic system 10 needs to be righted (i.e., turned right-side up). The robotic arm system 90 when attached to a robotic system 10, can adjust the weight distribution of a robotic system 10, by actuating the arm to a specific position, for example to minimize flipping the robotic system 10 over, the robotic arm system 90 may extend the arm to counterbalance a portion of the weight of the combined robotic system 10 and robotic arm system 90. This can balance the robotic system 10 on a ledge or precipice, stabilizing the robotic system 10 as the robotic system 10 navigates a steep embankment or uneven surfaces. The robotic arm system 90 may push or propel the robotic system 10 up or down an inclined surface, or over an obstacle.

As shown in FIG. 2, a protection device 500 can be used to reduce wear and tear on the robotic arm system 90 as the robotic arm system 90 interacts with the environment. The protection devices 500 can include padding, flexible protection devices resembling kneepads or elbow pads, helmets, plastic domes or shells, hard plastic mushroom caps, foam caps, foam padding tape, rubber bumpers, metal bumpers, thermal shielding, insulation, chemically inert coatings and sleeves, flexible membranes, putty, clay, galvanizations, or combinations thereof. The protection devices 500 can protect the base 100, modular arm 200, a modular arm joint, such as an elbow joint 250, at least one end effector 300, a camera 229, any other suitable part of the robotic system 10.

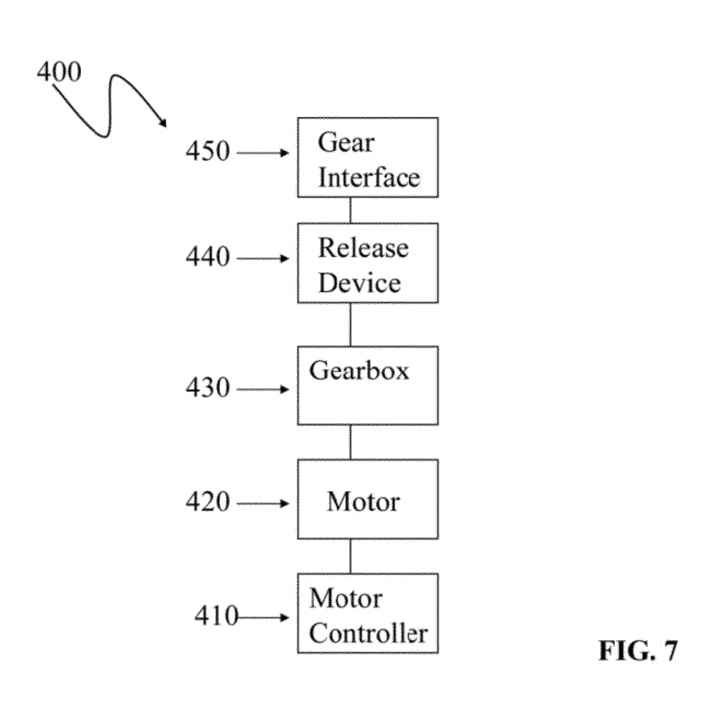

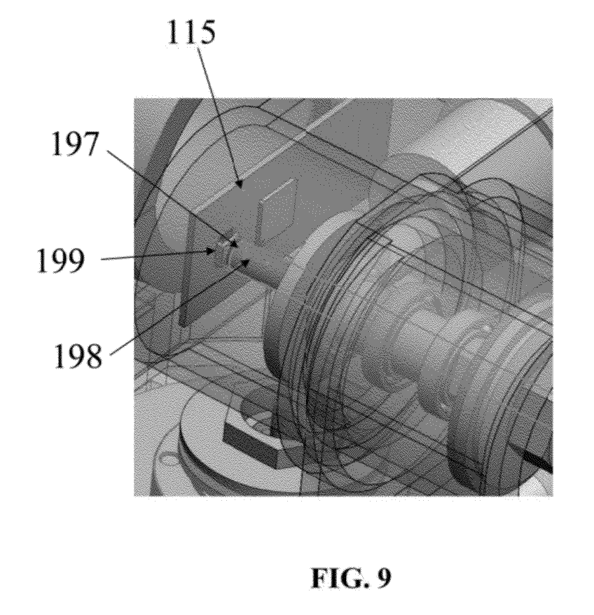

As shown in FIGS. 7 and 9, a motor system 400 can include a motor controller 410, a motor 420, a gearbox 430, a release device 440, and a gear interface 450. The motor controller 410 can be a brushless, brushed or stepper motor controller for a DC motor. The motor system 400 can have first and second motor controllers 411 and 412. The motor controllers 410, 411, 412 can have absolute and/or relative sensors, such as potentiometers, optical encoders, magnetic non-contact sensors, or combinations thereof, for example for tracking the position of the motor.

As shown in FIG. 9, a motor controller 115 can include a magnetic non-contact sensor 199 mounted on the PC board of motor controller 115. A rod 198 can be keyed to the joint spinning magnet 197 at the end near the magnetic non-contact sensor 199. The rod 198 can be non-ferrous to improve the functionality of the joint spinning magnet 197. The motor 420 can be a brushless motor, a brushed motor or stepper motor. The gearbox 430 can be optional.

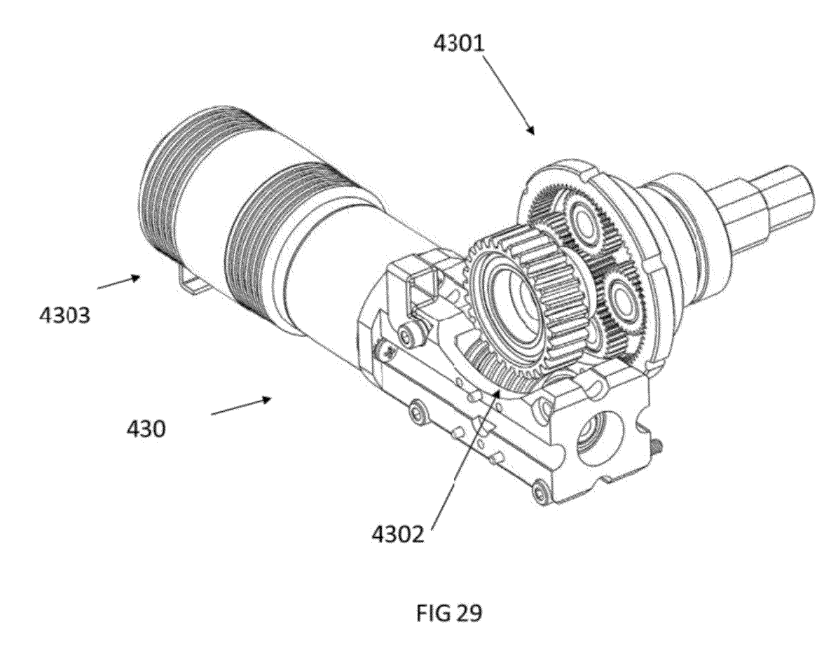

FIG. 29 illustrates that the gearbox 430 can be a 1 to 4 gearbox, a 1 to 35 gearbox. The gearbox 430 can be have planetary, spur, helical, bevel hypoid gears, or combinations thereof. The gearbox 430 can be non-backdrivable, right-angle high-torque gearbox, which can allow for a smoothly operating control loop that can use three stages of gearboxes (e.g., planetary at motor, right angle worm/hypoid, then final planetary). For example, the high-torque gearbox can deliver a maximum torque from about 10 Nm to about 100 Nm, more narrowly from about 20 Nm to about 60 Nm, for example about 45 Nm.

The gearbox 430 can have a first gear stage 4301, connected to the motor and a second gear stage. For example, the first gear stage 4301 can be or have a planetary gear. The second gear stage 4302 can also be connected to a third gear stage 4303. The second gear stage 4202 can have or be a hypoid or worm gear. The second gear stage can make a right turn from the first gear stage 4301 to the third gear stage 4303. The third gear stage 4303 can also be connected to an actuator or lever, for example an arm. The third gear stage 4303 can be a planetary gear. The third gear stage 4303 can be obscured by the third gear stage case. The gearbox 430 can deliver power at a perpendicular angle to the direction in which the gearbox 430 received the power.

The gearbox 430 can be connected to a release device 440. For example, the release device can connect between the gearbox 430 and the gear interface 450. The gear interface can connect directly or indirectly to the arms and/or the end effectors 330. The release device 440 can be a linear slip clutch, a ball detent, a slip clutch, any other mechanical or electromechanical release device, or combinations thereof. The gear interface or gearing interface 450 may include a shaft with a worm pinion interfacing with gears. The shaft can be supported by bearings, spacers, washers, thrustbearings, shaft supports, motor supports, or combinations thereof. The gearing interface 450 can include a hypoid-gearing interface, a spur gear interface (e.g., instead of a pinion-gear interface) and/or a planetary gear interface.

The robotic system 10 can have one or more motor systems 400, 401, 402, 403, 404, 405. Each motor system in the same robotic system 10 can be the same as every other, the same as some of the other, or different than every other motor system throughout the same robotic system 10. Multiple motor systems for a single robotic system 10 can each be customized for ranges of motion, degree of movement precision, or any other suitable application. The robotic system can have from about one to about ten actuators.

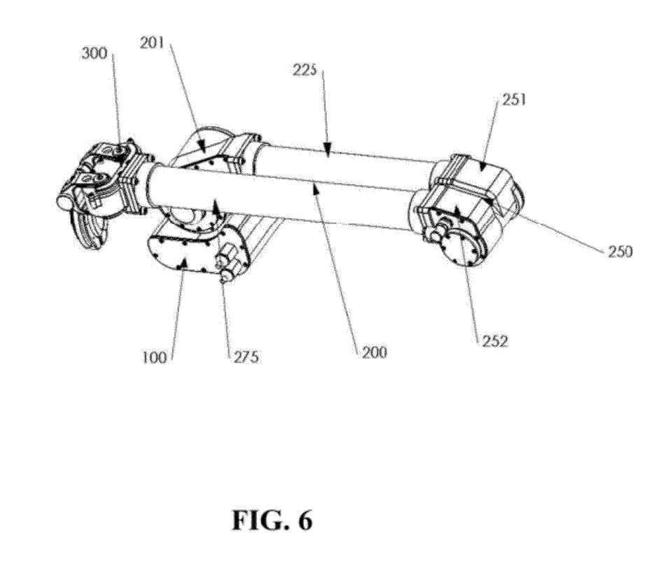

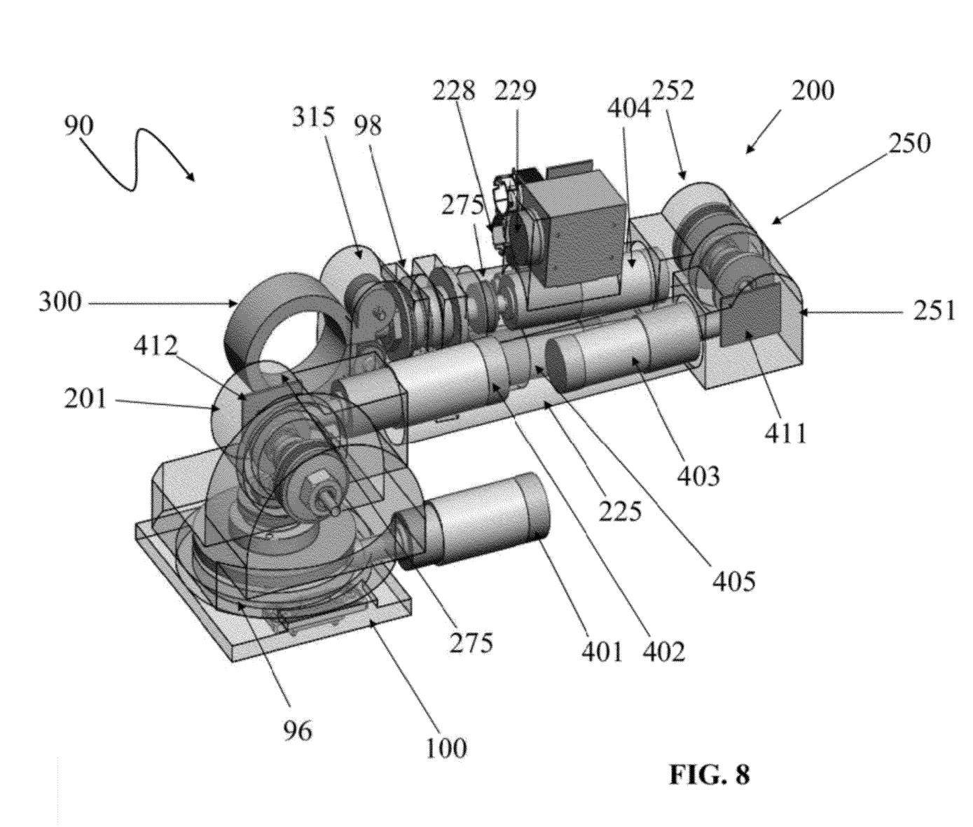

The base 100 can attach to the robotic system 10. As shown in FIGS. 2-6 and FIG. 8, the base 100 can attach to at least one payload port on the robotic system 10. The base 100 can mechanically support the robotic arm system 90. The base 100 can mechanically attach the robotic arm system 90 to the robotic system 10. Captive fasteners, such as thumbscrews that are attached to the arm base such that they can remain fixed to the arm base as the arm base is moved, can attach the base 100 to the robotic system 10. The captive fasteners can be held with the base 100 for quick (e.g., tool-less) attachment and/or detachment. For example, the captive fasteners can be held in place by mechanical features on the base 100, held in place by springs, locking mechanisms, cables attached to the base, or combinations thereof.

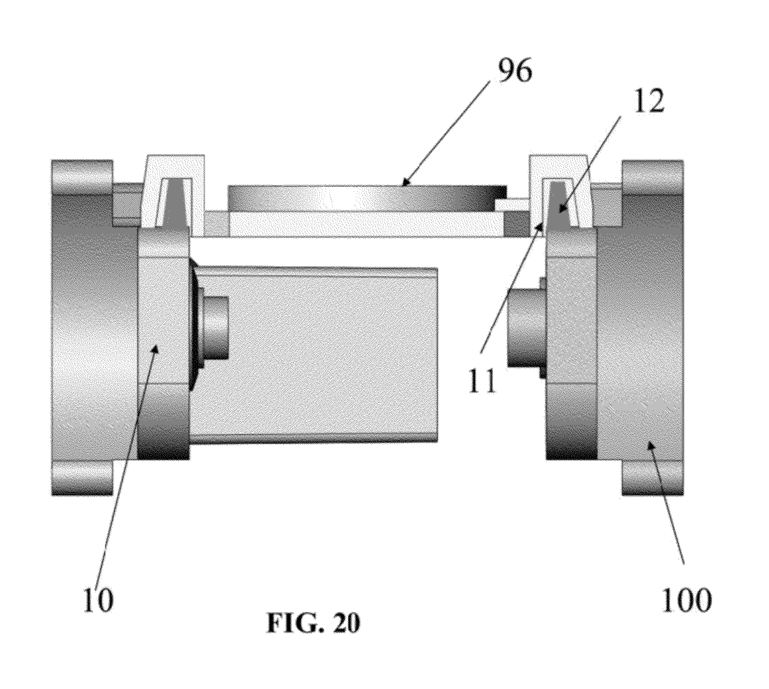

As shown in FIG. 20, the base 100 may contain guiding features at the interface between the robotic system 10 and the base 100 of the robotic arm system 90, for example grooves 12 mated to rails 11 on the body of the robotic system 10, to help align the robotic system 10 with the base 100 during assembly.

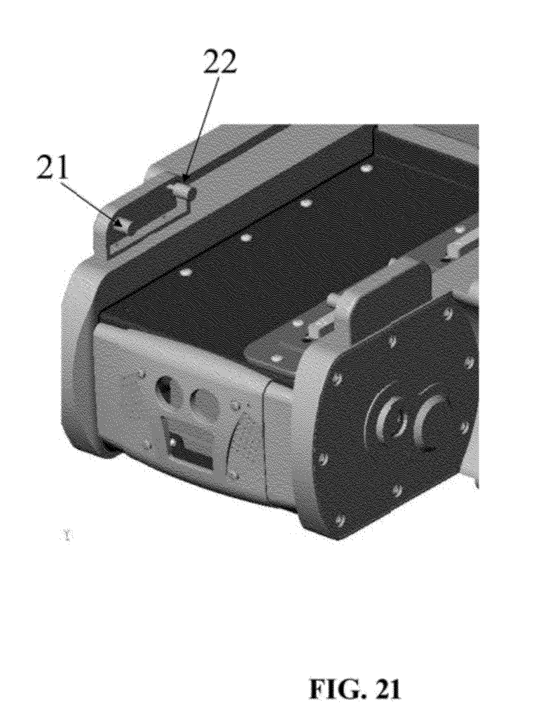

As shown in FIG. 21, cam follower mounts 22, 23 can guide the base 100 onto the chassis of the robotic system 10. The cam follower mounts 22, 23 can be removable by a user, for example, if they are not needed, or if the user would like the arm to possibly detach itself from the robotic system 10.

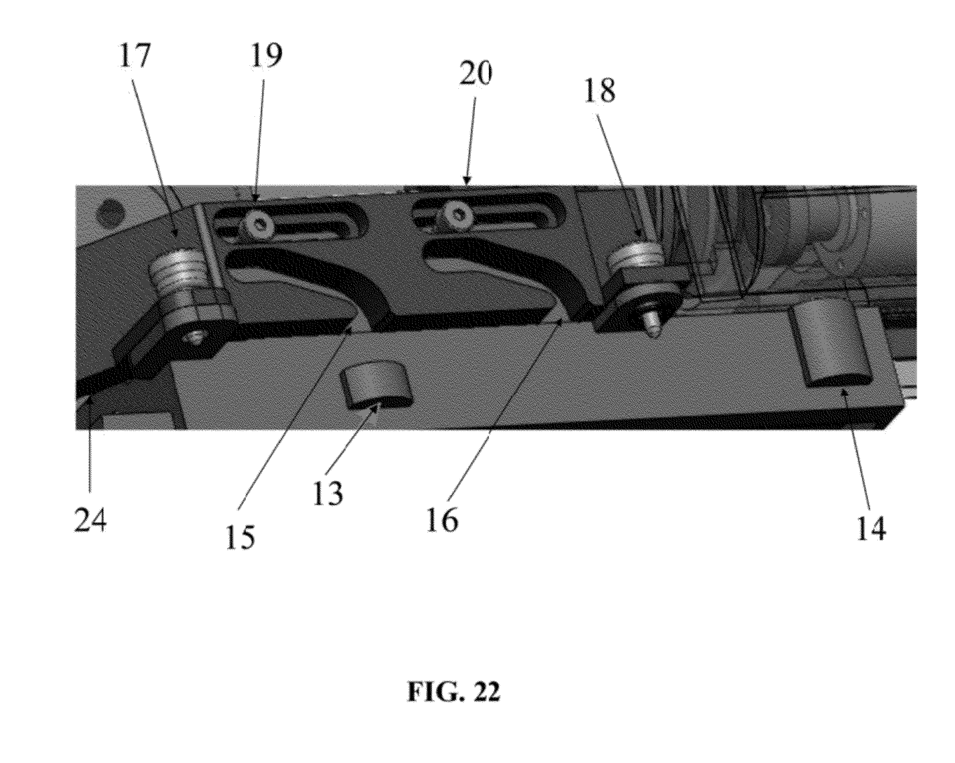

As shown in FIG. 22, at least two arm alignment features 13, 14 can be keyed to make sure the robotic arm system 90 is located in the correct position on the robotic system 10, including front-back and left-right positioning. The arm alignment features 13, 14 can be as long as possible without digging into the side seal of the robotic system 10, but alternatively the alignment features 13, 14 can dig into the side seal of the robotic system 10. At least two fasteners 17, 18 can hold down the robotic arm system 90 to the robotic system 10, and can immobilize the ejector as well, such that the ejector cannot be loosened until the fasteners 17, 18 are loosened. The fasteners 19, 20 can keep the ejector handle 24 sliding with the base 100. The cam follower slots 15, 16 can provide a mechanical advantage for the ejection of the robotic arm system 90 from the robotic system 10. The cam follower slots 15, 16 can include a 20-degree angle inside the cam following path—this can affect the insertion force required to attach the robotic arm system 90 to the robotic system 10, in that less insertion force can be required due to the weight of the robotic arm system 90 and gravity assisting the user during the attachment process.

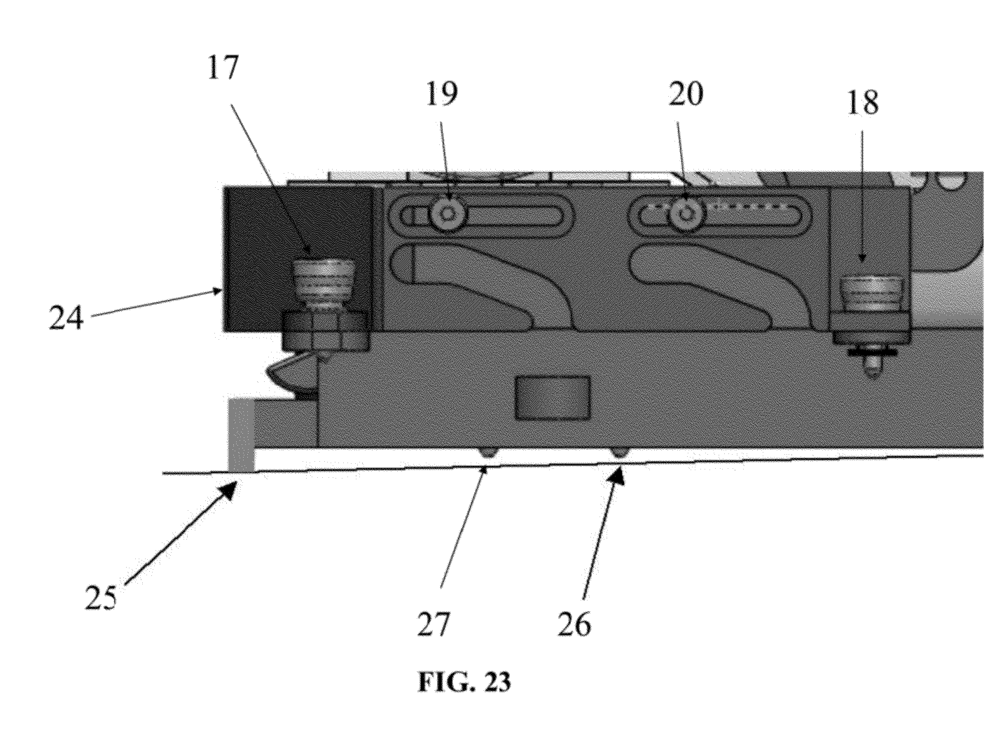

As shown in FIG. 23, the base 100 of the robotic arm system 90 can also include a foot 25, which can protect the connector pins 26, 27 from damage or bending if the robotic arm system 90 is set on a surface.

The base 100 can have a microprocessor controlling the motor controllers for each motor and communicating with the control board of the robotic system 10. The microprocessors can have and execute control logic software. The motor controllers for each motor can be housed in the base. The motor controls can be connected via wiring to the motors and/or the control board of the robotic system 10. The motor controllers can be housed right next to the motors. The motor controllers can all (or some) be wired directly to a port in the base 100 where the motor controller wiring will connect to the control board of the robotic system. The base 100 can include control logic connected to a controller board on the robotic system 10. The base can include the arm control logic that is controlled by the control board, and/or the arm control logic can be integrated onto the control, board.

The base 100 can interface with the control system in the robotic system 10. The base 100 may be connected to the robotic system 10 via at least one USB connection, wired and/or wireless connections, Ethernet connections, or combinations thereof. The base 100 can receive control signals from the control board of the robotic system 10. An operator can operate an operator control unit (OCU) for the robotic system 10. Control signals generated by the OCU, automatically or in response to the operator's input, can be processed and controlled at the system level by a main controller of the robotic system 10, and delivered to the base 100. The base 100 may communicate directly with an OCU for a robotic system 10 or an entirely independent and separate OCU. The robotic arm 90 may be controlled by an autonomous control program in a microprocessor giving the microprocessor autonomous capability to maneuver or manipulate the robotic arm system 90. Commands could come from the Internet via wifi, remote computer terminal, GPRS modem, satellite phone, mobile phone, infrared, Ethernet, Firewire, other wireless or wired connection protocols, or combinations thereof.

The base 100 may include a rotary joint 96 to provide axial rotation for the robotic arm system 90. The rotary joint 96 can be underneath the robotic arm system 90, for example between the interface (i.e., the connection between the body of the robotic system 10 and the base 100, as shown in FIG. 20 and mentioned above in paragraph 0016) with the robotic system 10 and the robotic arm system 90. The rotary joint 96 can be in the base 100, the lower shoulder gearbox output housing 201, or in the lower arm 225.

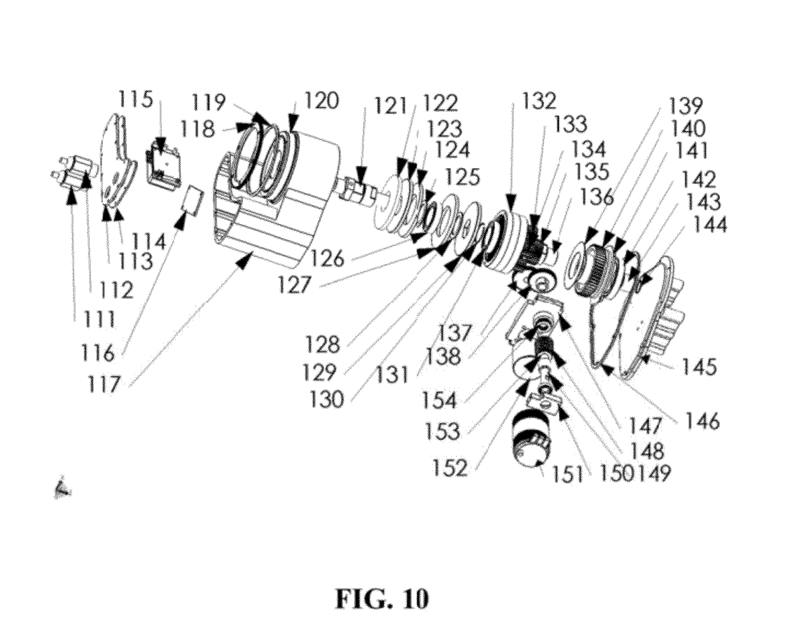

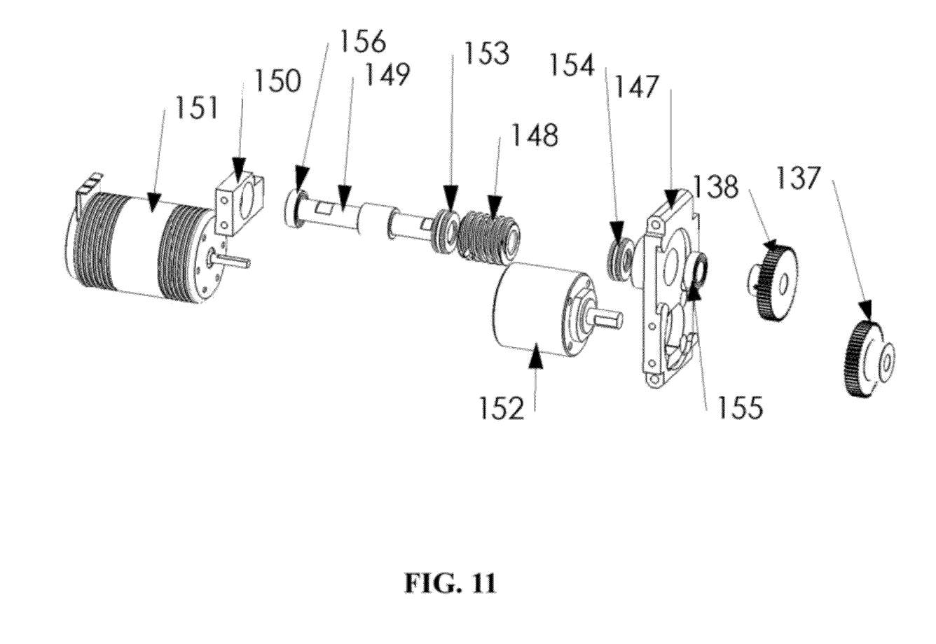

As shown in FIGS. 10-11, the base 100 of a robotic arm system 90 can have cable glands 111, 112 that can connect the robotic arm system 90, for example through cables (not shown) or direct connections through the cable glands 111 and 112, to the control and power source of the robotic system 10. The cable glands 111, 112 can deliver power and/or control signals to the motors, gearboxes, and other end effectors 300, cameras, and other devices on the robotic arm system 90, or combinations thereof.

The shoulder housing 117 can protect and seal the components of the base 100, including the robotic arm control board 116. The shoulder housing 117 can provide a mounting or fastening interface to the frame or structure of the robotic system 10. The shoulder housing electronics cover gasket 114 can seal the shoulder housing electronics cover 113 and can protect and seal the motor controller 115 and the robotic arm control board 116 from the environment. The motor controller 115 can be a brushless motor controller, for a DC motor or a stepper motor.

The gear 118 can be attached to a first side of the joint while interfacing with a small gear on a second side of the joint, opposite to the first side of the joint, that turns a potentiometer. This creates angular feedback between the two housings (i.e., first housing 117, and second housing is not shown in the figures) of the joint, regardless of the clutch status (e.g., whether the clutch is open or closed), motor position, motor speed, or combinations thereof. The gear 118 can interface with a gear-connected motor in the lower shoulder gearbox output housing 201. The shoulder o-ring 119 can seal the interface between the shoulder housing 117 and lower shoulder gearbox output housing 201, around the lip of the shoulder housing 120. The lip of the shoulder housing 120 can be mated to the lower shoulder gearbox output housing 201.

The sungear 135 can rotate around the shoulder shaft 121 on the sungear bearing 136. The sungear 135 can interface with at least one planetary gear, 133, 134. The planetary gears 133, 134 can be attached to a carrier plate (not shown in perspective) rotating with a bearing 131 between the carrier plate and the shoulder shaft 121. The planetary gear 133, 134 can interface with a single stage ring gear 132. The bearing 131 can be held in place with a snap ring 130.

The ring gear 132 can interface (e.g., the clutch disk/pack interfacing with the housing piece, which acts as pressure plate) with a clutch such that an external torque (e.g., about 100 N-m) on the robotic arm system 90 can be applied without damaging the motor 151. The clutch can slip, for example protecting the gear train and motor. The clutch plates 123, 129 protect the internal portions of the clutch and can interface with other rotary parts. The clutch plate 129 can interface with the shoulder shaft 121, and can enable rotary power from the planetary gearset to be transferred through the clutch friction disk clutch packs 124 to the shoulder gearbox output housing 201. The spacers 125, 128 can hold a bearing 126 inside of the shoulder clutch packs 124, 127. For example, when the clutch packs 124, 127 are pressed together, rotary power can be transferred from the two clutch packs 124, 127 to the shoulder gearbox output housing 201. The shoulder clutch bellevue 122 can compress the clutch packs 124 and 127 together. The shoulder clutch bellevue 122 can be made of steel, titanium, aluminum, plastic, or combinations thereof. A gear 137 can interface with a gearbox 152 and a gear 138. An additional gear 138 can interface with a gear 137 and the shoulder worm shaft 149.

The shoulder worm gear 140 can be aligned and supported by the worm gear bearing support 141. The worm gear bearing support 141 can rotationally support a ball bearing 142 around the sungear inner bearings 136 and 143. The sungear inner bearing 143 can be held in place with a snap ring 144. An internal washer 139 can be used to hold the shoulder worm gear 140 in place.

The shoulder housing cover 145 and the shoulder housing gasket 146 can seal the shoulder housing and protect the components housed inside from moisture, particles, temperature and other elements, and can enable easy access for repairs, replacements or modifications.

The shoulder motor mount 147 can attach, support and align the motor 151 within the shoulder housing 117. The motor 151 can be a brushless, brushed, or stepper motor. The motor 151 can be connected to a 4-to-1 gearbox 152. The 4-to-1 gearbox 152 can enable various speeds and precisions of articulation of the shoulder. The gearbox 152 can interface with a shoulder worm shaft 149. The shoulder worm shaft 149 can be aligned and supported with bearings 155, 156 and thrustbearings 153, 154 located around the shaft and between the shoulder worm shaft 149, the shoulder motor mount 147, and the shoulder worm bearing support 150. The elbow worm pinion 148 is also adapted to turn with the shoulder worm shaft 149, and interfaces with the shoulder worm gear 140.

The thrustbearings 153, 154 and the bearings 155, 156 can protect the rotation of the shoulder worm shaft 149. The thrustbearings 153, 154 can be about 8 mm in diameter. The bearings 155, 156 can be about 14×8×4 mm bearings. The bearing 142 can be or have about 30×42×7 mm ball bearing The bearing 131 can be a ball bearing about 32×20∴7 mm.

As shown in FIGS. 2-6, the modular arm 200 can have a lower arm 225 and an upper arm 275. A lower elbow joint or shoulder joint can connect the lower arm 225 to the base 100. An upper elbow joint 250 or shoulder joint can connect the lower arm 225 to the upper arm 275. The upper arm 275 can be connected to at least one end effector 300. The joint 250 can be an elbow joint, a wrist joint a shoulder joint, or combinations thereof. At least one end effector 300 may be connected to additional joints or modular arms. The modular arm components and/or joints may include payload interfaces to expand functionality of the robotic arm system 90. The modular arm 200 may include telescoping sections, and electronic or mechanical interfaces for additional modular arm connections, components, and/or devices.

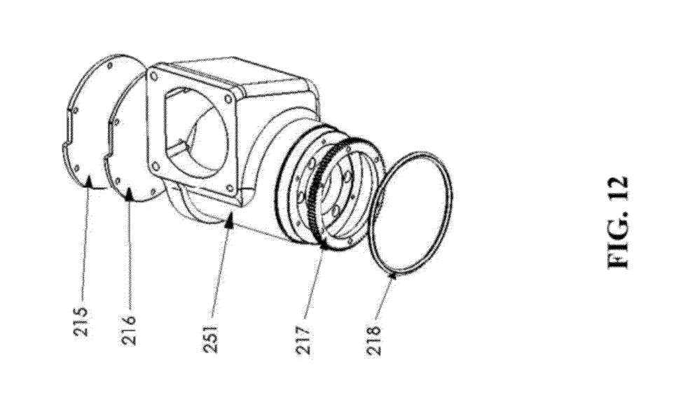

As shown in FIGS. 2-6 and FIGS. 12-14, the lower arm 225 can be connected to the shoulder joint of the base 100 using the lower shoulder gearbox output housing 201. The lower arm 225 can be connected to the upper arm 275. The upper arm 275 near the elbow joint 250, the elbow joint 250, the lower arm 225 near the elbow joint, or combinations thereof, can be sealed and protected by the elbow gearbox input housing 251. The upper arm 275 can be connected to the lower arm 225 at the elbow joint. The upper arm 275 near the elbow joint 250, the elbow joint 250, the lower arm 225 near the elbow joint, or combinations thereof, can be sealed and protected with the elbow gearbox output housing 252.

The internal sungear 257 can interface with the elbow worm gear 255. The interface between the internal sungear 257 and the elbow worm gear 255 can be keyed. The elbow ring gear bearing support 256 can hold a bearing 258 around the interface between the internal sungear 257 and the elbow worm gear 255. The bearing 258 can be held in place with a snap ring 259. A washer 260 can provide a thrust bearing surface for the planetary gears 262.

The internal sungear 257 can interface with at least one planetary gear 262 attached to a carrier plate 264. The planetary gear 262 attached to the carrier plate 264 can interface with a ring gear 261. An elbow ring gear bearing support 265 can align the bearings 263, 266 around the carrier plate shaft 264.

The elbow clutch pressure plates 267, 271 can hold a bearing 268 inside of the elbow clutch packs 269, 270. For example, when the elbow clutch packs 269, 270 are pressed together, rotary power can be transferred from the clutchpacks 269, 270 to the elbow joint housing 252. The elbow clutch pressure plates 267, 271 can be keyed to avoid rotation movement around the elbow worm shaft 281, for example transferring torque from the surfaces of the clutch pressure plates 267, 271 to the clutchpacks 269, 270. The elbow clutch bellevue 272 can provide force that can compress the elbow clutch packs 269, 270 together. The elbow clutch bellevue 272 can be made of steel, titanium, aluminum, plastic, or combinations thereof. The elbow clutch nut 273 can support the elbow clutch bellevue 272. The elbow clutch nut 273 can hold the elbow clutch bellevue 272 in place on the elbow worm shaft 281 as the elbow clutch bellevue 272 applies pressure on the elbow clutch pressure plates 267, 271 and the elbow clutch packs 269, 270. The elbow clutch nut 273 can be adjusted to adapt the spacing. As the surfaces wear down on the clutch packs the clutch nut can be adjusted to keep the adjacent parts held tightly together, for example to maintain maximum torque transfer. The elbow clutch nut 273 can include a starred washer, for example for spreading the load of the bellevue 272. The elbow clutch nut 273 can include a variety of locking mechanisms, keys, set screws, pins, washers, or combinations thereof, to keep the elbow clutch nut 273 from rotating with respect to the threaded elbow worm shaft 281 during use.

The motor 277 can be connected to a 14--to-1 gearbox 278. The elbow worm pinion support 279 can align and/or support the elbow worm shaft 281.

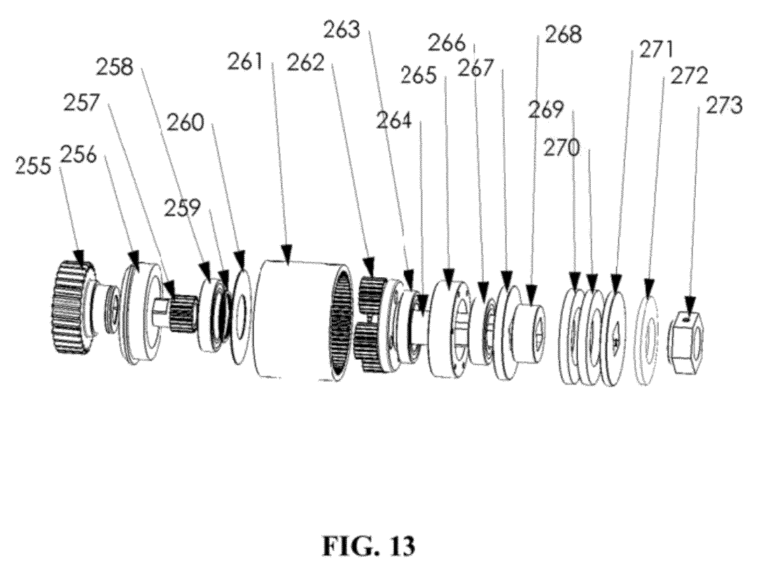

As shown in FIG. 13, the elbow sensor gear 217 can interface with an elbow worm pinion 284 attached to a gear motor system for the upper elbow joint 275. The elbow sensor gear 217 can rotate with the upper arm relative to the lower arm, when the gear motor system for the upper elbow joint 275 is actuated. The sensor gear 217 can send a position value of the upper arm to the control microprocessor.

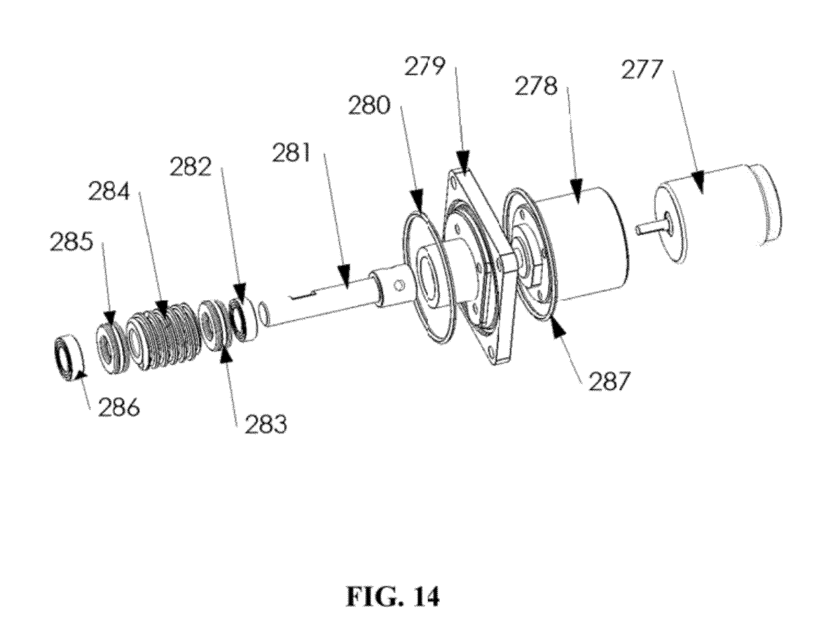

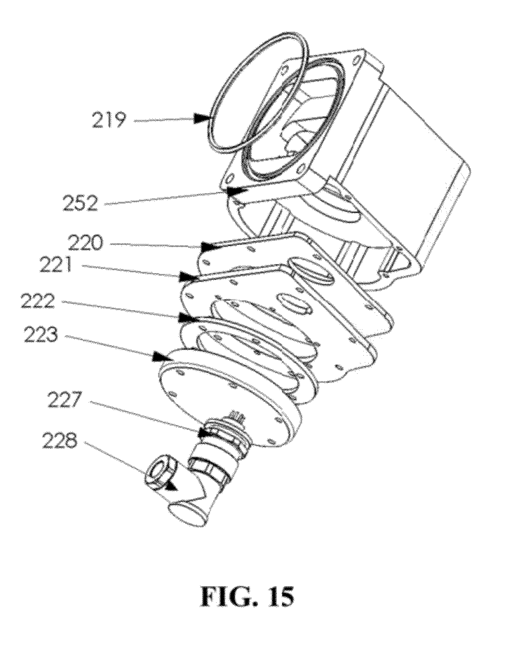

As shown in FIGS. 13-14, the elbow housing cover gaskets 216, 220 can seal the elbow housing covers 215, 221 and can protect and seal the components of the elbow joint 250. The elbow clutch cap gasket 222 can seal the elbow clutch cap 223, and can protect and seal the components of the elbow joint 250.

The o-rings 218, 219, 280, 287 can seal the motor 277, gearbox 278 and other components from moisture, particles and other elements. The o-rings 219, 280 and 287 can be about 1.5 mm in thickness with about a 40 mm diameter. The o-ring 218 can be about 2 mm in thickness with about a 47 mm diameter.

The thrustbearings 283, 285, and the bearings 282, 286 can protect the rotation of the elbow shaft 281. The thrustbearings 283, 285 can be about 8 mm in diameter. The bearings 282, 286 can be about 14×8×4 mm.

The I/O connector 227 can connect to additional input/output devices, which may include Ethernet, USB, IEEE 1394 (FireWire), audio, or combinations thereof. The I/O connector 227 can communicate with the robotic arm control board 116, and/or the control board of the robotic system 10. The I/O connector can be USB, and can support up to 127 extra devices (as per the USB specification). For example, the I/O connector can have 1 to 127 nodes available. Additional devices such as the camera 229, or additional motors can be attached to the USB bus, and managed by a USB controller in software or hardware. The individual motor controllers for each axis of motion of the robotic arm system 90 can also be attached to and controlled via the USB bus.

The camera connector 228 can be connected to the camera 229. The camera connector 228 can communicate with the control board of the robotic system 10. The camera 229 can connect to the camera connector 228. The camera 229 can be a webcam, a forward-looking infrared (FLIR) camera, CCD, CMOS, CCIQ, multiple cameras, a zoom camera, wide angle camera, or any combinations thereof. Localized lighting for each camera, such as LED's, IR LED's, a camera flash, or any other suitable lighting source or combination thereof may also be attached to the camera connector 228, the camera 229, or an I/O connector 227.

The robotic arm system 90 can have a supplemental camera. For example, the supplemental camera can be attached to a boom or mini arm extending from the robotic arm. The supplemental camera can be positioned to look down at the primary camera 229 and/or the gripper. For example, the supplemental camera can provide a second, simultaneous view from a different perspective than the primary camera 229. The visual data from supplemental camera and the primary camera 229 can be processed with the relative position data for each camera (e.g., from respective sensors, such as potentiometers) to create a three-dimensional image or a navigatable virtual space. The primary camera 229 can have a primary light attached to the primary camera 229 or on the arm adjacent to the camera 229. The supplemental light can have a supplemental light attached to the supplemental camera or on the boom or arm adjacent to the supplemental camera.

As shown in FIGS. 1-3, an end effector 300 can be attached or detached at the end of the robotic arm 300. The end effector can be attached at any portion of a modular arm 200 including a lower arm 225, an upper arm 275, or modular arm joint 250, interfacing through the lower arm elbow joint housing 251 or the upper arm elbow joint housing 252. The robotic arm system 90 can have multiple end effectors 300. Each end effector can interact with the environment and can provide additional functionality (i.e., different than the other end effectors) to the robotic arm system 90 and/or the robotic system 10. The end effector 300 can be detachable and replaced with en alternate end effector 300. The end effector 300 can have one or more grippers, hooks, shovels, blowers, winches, pokers, sampling devices, pressure sensitive devices, cameras, microphones, chemical sensors, optical sensors, temperature sensors, or combinations thereof. The blower can be a pressurized blower, for example a compressed air delivery device, pressure vessel (e.g., can) of compressed air, fan, or combinations thereof.

The end effector 300 can be attached to a wrist joint 98 at the end of the modular arm 200 to enable additional degrees of motion and precision control.

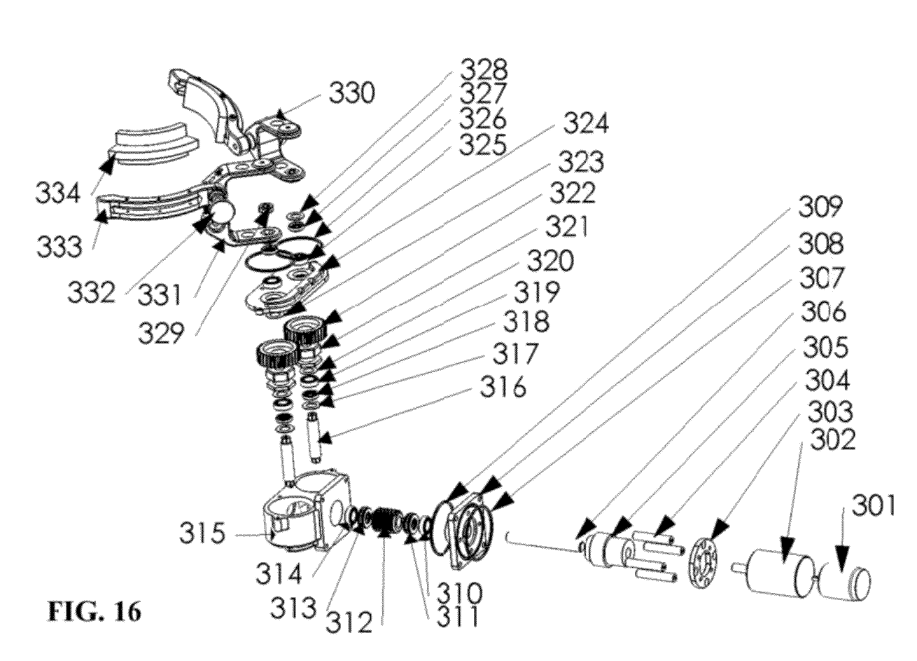

As shown in FIG. 16, the end effector 300 can include a motor 301. The motor 301 can be connected directly or through a gearbox to the gripper shaft 306 to actuate at least one gripper finger 330. The motor 301 can be connected to the gripper shaft 306 through a gearbox 302 and a clutch device 305. The clutch device 305 can be a continuous slip clutch, a ball-de-tent, or a combination thereof. The gearbox 302 can be about a 189-to-1 gearbox. The gripper motor 301 can be mounted on a gripper motor mount 303. One or more gripper motor mount standoffs 304 can be used, for example if extra spacing is needed within the arm for extra components such as a clutch device 305. The gripper motor mount standoff 304 can be made of aluminum, any structural metal, resin, plastic, composite, or combinations thereof.

The gripper worm pinion support 308 can support and align the elbow worm pinion 312 on the gripper worm shaft 316. The gripper worm pinion support 308 may include interfaces for sealing with o-rings 307,309. The gripper worm pinion support 308 can interface with the gripper housing 315. The gripper worm pinion support 308 can interface with a wrist joint, for example to provide an additional axis of rotation to at least one gripper finger 330.

The gripper housing 315 can contain a gripper worm shaft 316. The gripper worm shaft 316 can interface with an elbow worm pinion 312. The elbow worm pinion 312 can interface with at least one gripper worm gear 322 inside the gripper housing 315.

The elbow worm pinion 312 can interface with two identical gripper worm gears. Each gripper worm gear can torque a corresponding gripper finger 330. The gripper worm gear 322 can interface with the gripper worm shaft 316. The gripper worm shaft 316 can interface with the gripper shaft torquer 329, for example to torque a gripper finger 330. The gripper housing can be closed and sealed with a gripper housing cap 324. The gripper housing cap 324 can align and protect the components inside the gripper housing 315.

The gripper shaft torquer 329 can interface with the gripper finger 330 via the gripper digit 331. The gripper shaft torquer 329 can interface with the gripper worm shaft 316. For example when the gripper worm shaft 316 torques, the gripper shaft torquer 329 can torques the entire gripper finger 330. The interface between the gripper shaft torquer 329 and the gripper digit 331 can be keyed. The interface between the gripper shaft torquer 329 and the gripper worm shaft 316 can be keyed. The keying can be a hex-keying pattern.

The gripper worm shaft 316 can be protected and aligned using shims 317, 320, 323. The shim 317 can be about 14×8×0.3 mm. The shim 320 can be about 14×8×0.1 mm. The shim 323 can be about 14×8×0.1 mm. The gripper oil seal 318 can seal in lubricant to protect and align the gripper worm shaft 316. The bearing 319 can be about 14×8×4 mm.

The gripper locking hub 321 can interface with the gripper worm shaft 316, and the gripper worm gear 322. When the gripper worm gear 322 rotates, the gripper kicking hub 321 can transmit torque to the gripper worm shaft 316.

The end effecter 300 can include at least one gripper finger 330. The gripper finger 330 can include a gripper digit 331. The gripper digit 331 can be connected to a gripper grip 333 using a fastener such as a shoulder bolt 332. The gripper finger 330 may include a gripper pad 334, for example to protect fragile objects or surfaces the gripper finger 330 contacts. The gripper pad 334 can be made of foam rubber, elastomers, synthetic and natural rubbers, or combinations thereof.

The o-rings 307, 309 can seal the gripper motor 301, gearbox 302 and clutch device 305. The o-rings 307, 309 can protect the gripper motor 301, gearbox 302 and clutch device 305 from moisture, particles and other elements. The o-rings 307 and 309 can be about 1.5 mm thick and about 40 mm in diameter around the entire o-ring.

The thrustbearings 311, 313, and the bearings 310, 314 can protect the rotation of the gripper shaft 306. The thrustbearings 311, 313 can be about 8 mm in diameter. The bearings 310, 314 can be about 14×8×4 mm.

The bearing 325, o-ring 326, gripper oil seal 327 and shim 328 can seal, align and protect the rotation of the gripper finger 330. The bearing 325 can be about 14×8×4 mm. The o-ring 326 can be about a 1.5 mm internal diameter thickness with about a 36 mm diameter. The gripper oil seal 327 can be a single lip or double lip shaft seal. The shim 328 can be about 14 mm by about 8 mm by about 0.3 mm.

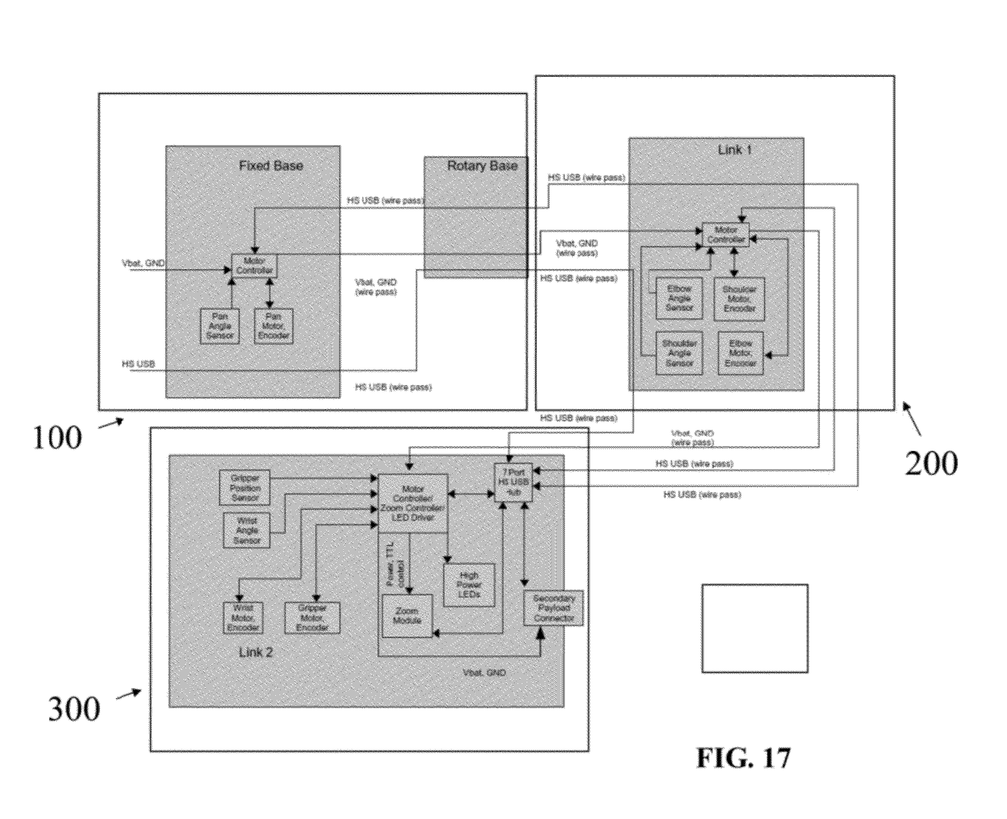

As shown in FIG. 17, the power and control wiring for the end effector 300 can be fed through hollow portions of the modular arm 200. Wiring to connect each motor controller to the control board of the robotic system 10 or the robotic arm system 90 can go through mouse holes and other mechanical clearances. The wiring can be routed through the centers of the gears and shafts. The motor controllers may be connected to a centralized motor controller. The centralized motor controller can receive inputs from encoders on one or more elbow motors, shoulder motors, elbow angle sensors, shoulder angle sensors, wrist motors, and wrist position sensors, or combinations thereof. Multiple devices, including an LED driver, a camera controller, a zoom module, and additional payloads can be connected to an additional bus connection, for example a Universal Serial Bus (USB). The bus may be centralized at any point throughout the robotic arm system. The bus may be distributed in any fashion across the base 100, the modular arm 200, and/or the end effector 300. The control wiring may be enclosed in a sheath or a conduit. The sheath or conduit may be housed internally or externally relative to the robotic arm system 90. For example the control and power wiring could be fed from the shoulder casing, through the shoulder arm housing 201, through the lower arm 225, through both the lower elbow joint housing 251 and the upper elbow joint housing 252 of the elbow joint 250, and through the upper arm 275 to interface with the end effector, or any combination thereof. The wiring path may terminate at any point to interface with another end effector, or another device, such as a camera, a microphone, a sensor, a sprayer, a blower, or any combination thereof.

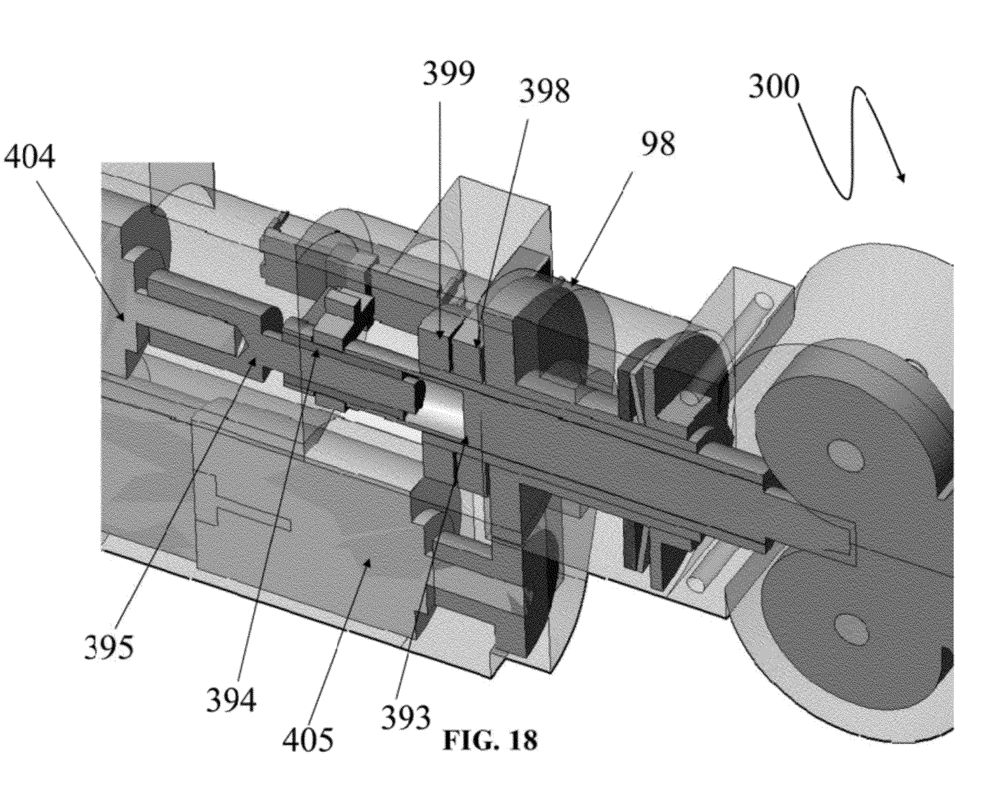

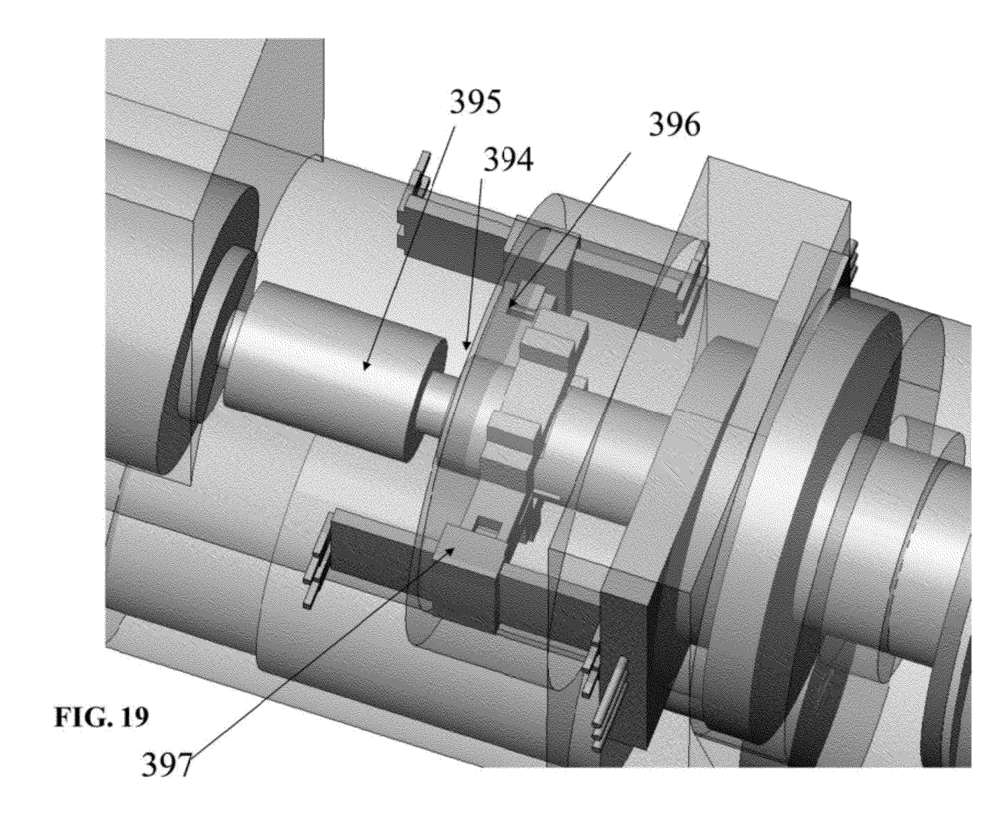

FIGS. 18 and 19 illustrate that the end effector 300 can have an end effector override mechanism. Sensors, such as two “through hole” potentiometers 398, 399 that can sense the rotation of the wrist joint, and can provide override protection. The two potentiometers 398, 399 can read 360 degrees or about 360 degrees of rotation of the wrist joint about an axis of rotation concurrent with the longitudinal axis of the end effector 300 and/or upper arm 275. The position and angle of the gripper finger 330 can be determined by the slider potentiometer 397. The slider potentiometer 397 can sense a gripper position. An additional slider potentiometer 396 can sense the acme nut 394 position, the position of the lead screw 395, the position of the lead screw 395 into the acme nut 394, rack 393 or combinations thereof. When the potentiometers detect that the position, velocity, acceleration or jerk (i.e., change of acceleration with respect to time) of the rotation of the gripper finger 330, acme nut 394, the lead screw 395, rack 393, or combinations thereof, is beyond an acceptable limit, the potentiometers signal can trigger (e.g., through a processor) a signal to activate the release device 440 to disengage the gearbox 430 from the gear interface 450, for example by opening the clutch. The clutch in the release device 440 can additionally be designed to mechanically slip when the position, velocity, acceleration or jerk (i.e., change of acceleration with respect to time) of the rotation of the gripper finger 330, acme nut 394, the lead screw 395, rack 393, or combinations thereof, is beyond an acceptable limit.

The brass acme nut 394 can slide inside of the rack 393. The rack 393 can move in a linear motion to open and close the gripper finger 330. When a large, overloading force is applied to the gripper finger 330, the overloading force can be transferred to the rack 393 in the. form of a linear motion. The transfer of the force can overcome the press-fit between the rack 393 and gripper finger 330, causing the difference in the two potentiometer values to change. That way, the logic software can conclude that the gripper finger 330 was stressed, and can correct the potentiometer values by closing the gripper finger 330, and using the motor to force the acme nut 394 to slide inside of the rack 393.

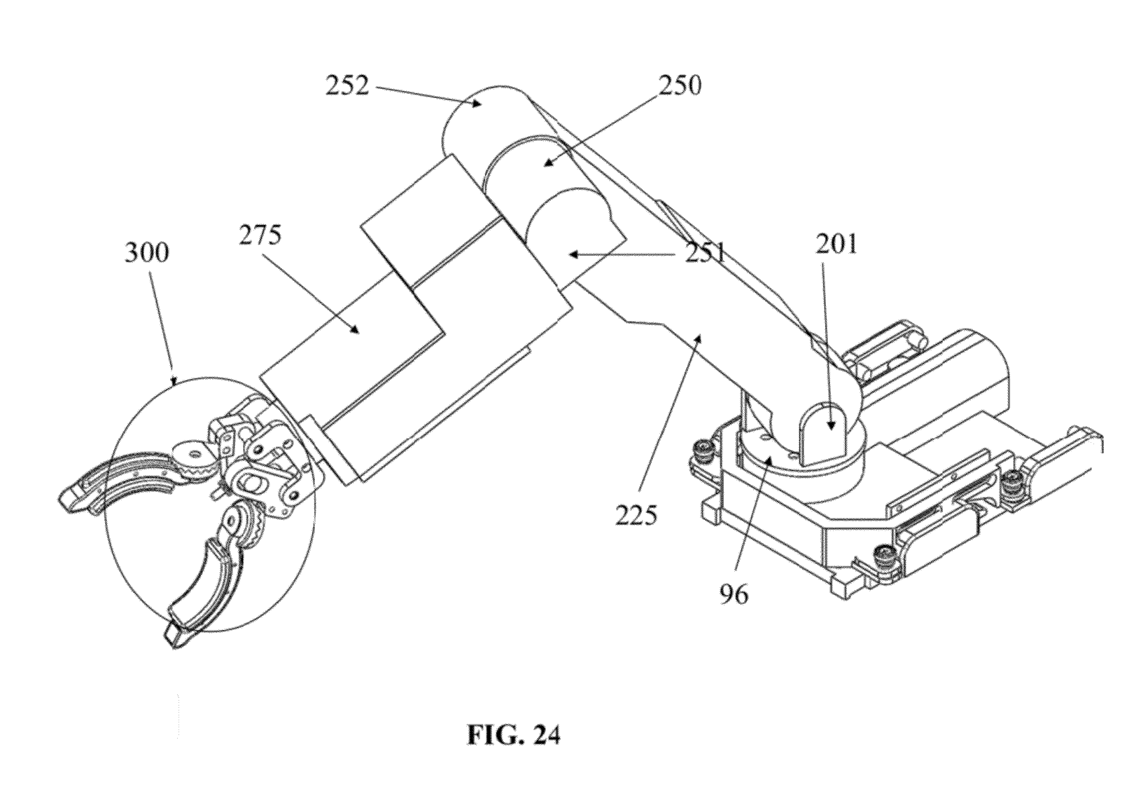

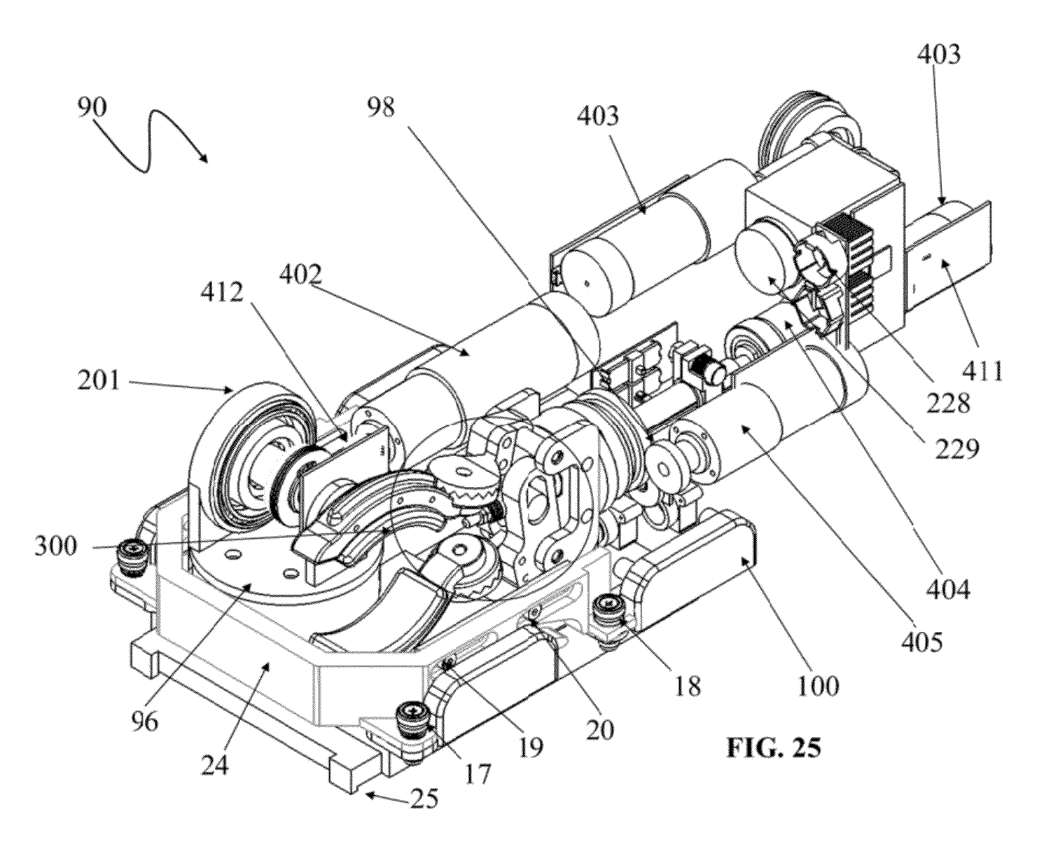

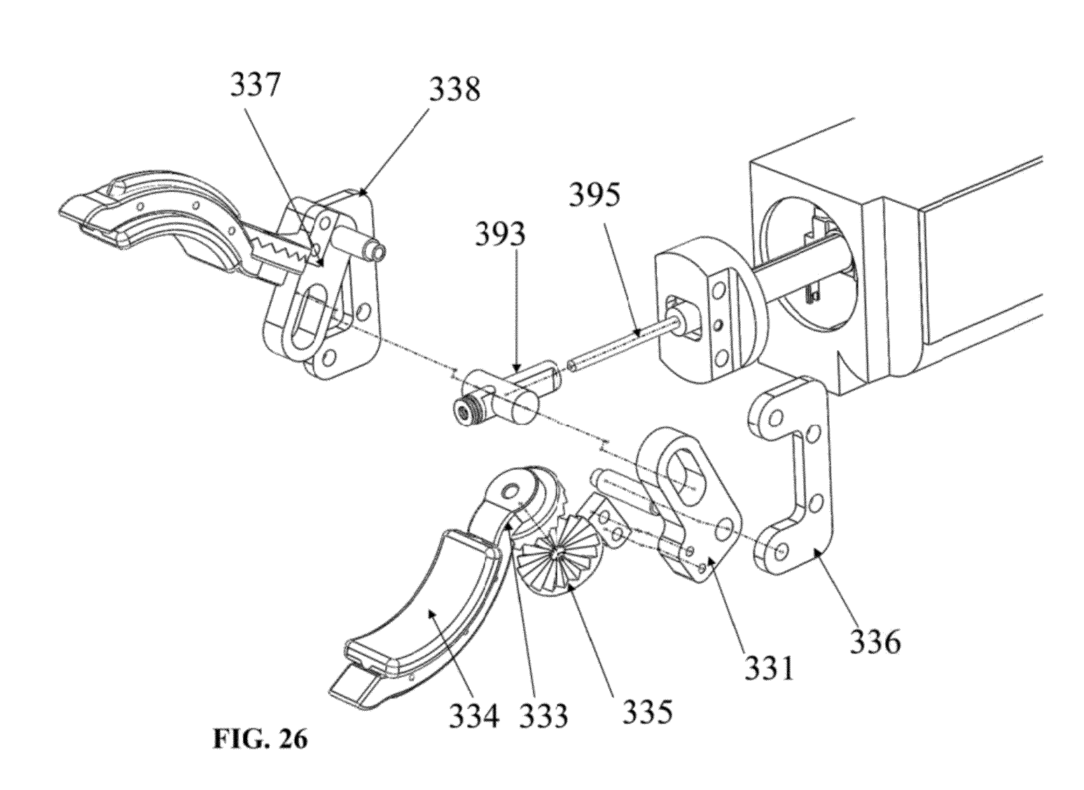

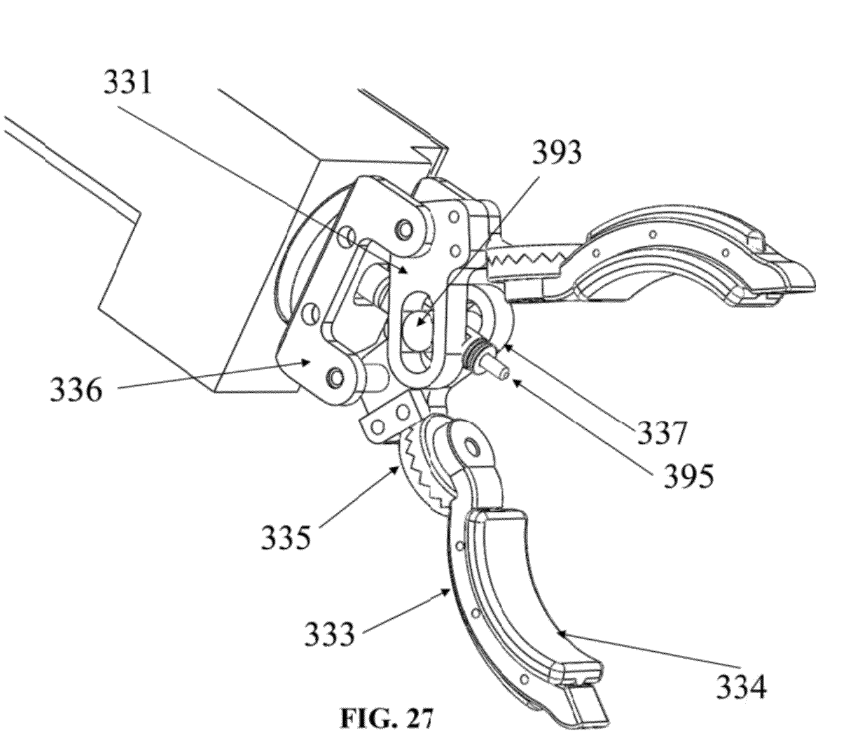

Another end effector 300 is shown in FIGS. 24-27. As shown in FIG. 24, a As shown in FIGS. 26-27, this end effector 300 can use identical gripper digits 331, 337 that can be articulated with the motion of a single rack 393.

The gripper digits 331, 337 can be identical to improve manufacturing, servicing, and assembly of the end effector 300, but can alternatively be different digits or mechanical devices, depending on the functionality of the end effector 300.

The gripper grip 333 can be aligned or angled with a finger alignment plate 335. The finger alignment plate 335 can interface with the gripper grip 333 using a keyed interface or other interlocking or non-interlocking interface, but any suitable interface can be used. The finger alignment plate 335 can adjust the angle or alignment of the gripper grip 333.

The digit locking plate 336, 338 can attach, support and align the gripper digits 331, 337 in position around a rack 393, such that when the position of the rack 393 is adjusted, the gripper digits 331, 337 can move simultaneously. Gripper digits can be fixed relative to the rack 393 or another gripper digit.

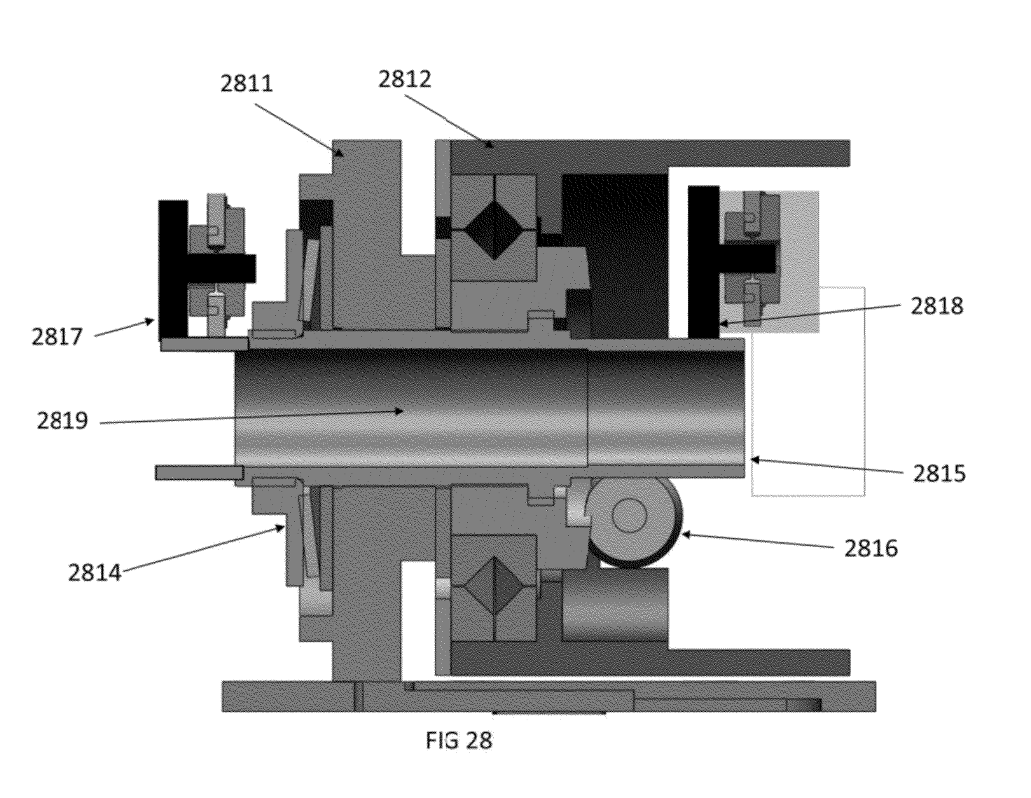

As shown in FIG. 28, an alternative joint structure for elbow joints, shoulder joints and wrist joints on the robotic arm system 90 can include at least two linked elements in the joint 2811, 2812, which can be connected by a shaft 2815 which can interface with a hypoid gear 2816 inside linked element 2812, and can also interface with a friction clutch 2814 or slip clutch or other mechanical release inside linked element 2811. A single sensor 2818 can track the movement of the shaft, however, Even though linked elements 2817 and 2818 can be limited to 180 degree rotation, since the shaft 2815 can rotate 360 degrees due to the slip clutch, using at least two sensors 2817, 2818 can be used to more accurately track the position of the joint elements with respect to one another, measuring the rotation of the shaft 2815 as it rotates on the hypoid gear side (inside linked element 2812) and on the friction clutch side (inside linked element 2811) particularly when the friction clutch is slipping on the interface to the joint element 2811, and the difference in movement can be calculated from the relative measurements of the sensors 2817, 2818. The sensors 2817, 2818 can be potentiometers, but may also be optical wheel encoders, or any other suitable sensor. The inside 2819 of the shaft 2815 can be used for a wire pass.

A cooling device can be attached to the base 100 or any joint that uses a motor controller for active cooling in extreme operating conditions (e.g. high temperatures). The cooling device can use heat pipes to pull heat out of the electronics and motors toward a heatsink that is cooled by a blower/fan on the outside of the arm. The cooling device can be configured to perform a refrigeration cycle and have a compressor and an evaporator. The cooling device can be configured to cool the motors and/or joints. The robotic arm system 90 can have a thermostat that can turn the cooling system on or off, for example, based on the temperature of a component, such as the motors and/or joints.

Throughout the entire robotic arm system 90, fasteners such as machine screws, bolts, snaps, hooks, rivets, nails, ties, glue, welds, spot welds, or combinations thereof, can be used to connect any or all of the components together.

The elbow joints can have a single rotational degree of freedom. The elbow joints can have single linear hinge joints. The axis of rotation of the rotational degree of freedom of the elbow joint can be perpendicular to the longitudinal axis of one or both arms, base or end effectors interfacing with the joint.

The wrist joints can have one or two rotational degrees of freedom. The wrist joints can have one or two linear hinge joints. Each hinge joint can have a rotational axis perpendicular to the rotational axis of the other hinge joint in the wrist joint

The axes of rotation of the rotational degree of freedom of the wrist joint can be perpendicular and/or parallel (e.g., coaxial, coincident) to the longitudinal axis of one or both arms, base or end effectors interfacing with the joint.

The shoulder joints can have three rotational degrees of freedom. The shoulder joints can have three linear hinge joints. Each hinge joint can have a rotational axis perpendicular to the rotational axis of the other hinge joints in the shoulder joint, and/or a ball-in-socket joint.

“Interface” is used throughout this disclosure to mean connect to, rotatably and/or translatably attach to, releasably or non-releasably fix to, press against, contact, or combinations thereof.

The robotic system 10 can include any of the systems and elements disclosed in U.S. Pat. No. 8,100,205, issued 24 Jan. 2012, which is incorporated herein by reference in its entirety.

As a person skilled in the art will recognize from the previous detailed description and from the figures and claims, modifications and changes can be made to the variations of the invention without departing from the scope of this invention defined in the following claims. Elements, characteristics and configurations of the various variations of the disclosure can be combined with one another and/or used in plural when described in singular or used in plural when described singularly.

We claim:

1. A robot system comprising:
a mobile robot;
a robotic arm system attached to the robot; wherein the robotic arm system comprises:
an arm base;
an arm;
a gripper attached to the arm at an end effector attachment location; and
a gripper override mechanism comprising a sensor and a clutch, wherein the clutch comprises a linear slip interface.

2. The system of claim 1, further comprising a captive fastener attaching the arm base to the mobile robot.

3. The system of claim 2, wherein the captive fastener comprises a thumbscrew attached to the arm base.

4. The system of claim 1, further comprising a motor; and
a gearbox, wherein the gearbox comprises a non-backdriveable, right-angle high-torque gearbox.

5. The system of claim 4, wherein the gearbox comprises two stages of gears.

6. The system of claim 5, wherein the gearbox comprises a first planetary gear attached to a motor, a right angle worm gear attached to the planetary gear at the motor, and a second planetary gear attached to the right angle worm gear.

7. The system of claim 1, wherein the gripper is detachably attached to the robotic arm system at the end effector attachment location.

8. The system of claim 7, further comprising a poker configured to be detachably attached to the robotic arm system at the end effector attachment location.

9. The system of claim 7, further comprising a blower configured to be detachably attached to the robotic arm system at the end effector attachment location.

10. The system of claim 1, wherein the arm has a payload interface, and wherein a camera connector is attached to the payload interface.

11. The system of claim 1, wherein the arm has a payload interface, and wherein an arm extension is attached to the payload interface.

12. The system of claim 1, wherein the arm has a payload interface, and wherein a second gripper is attached to the payload interface.

13. The system of claim 1, wherein the robot has a chassis, and wherein the arm base has a base alignment feature, and wherein the base alignment feature is mated with a chasses alignment feature in the chassis of the robot.

14. The system of claim 1 further comprising an expandable data bus comprising a node.

15. The system of claim 14, further comprising at least one motor controller connected to the expandable data bus.

16. The system of claim 14, further comprising at least one peripheral connected to the expandable data bus.

17. The system of claim 16, wherein the peripheral connected to the expandable data bus is a camera.

18. A robot system comprising:
a mobile robot;
a robotic arm system attached to the robot; wherein the robotic arm system comprises:
an arm base;
an arm;
a motor configured to drive motion of the arm; and
a gearbox, wherein the gearbox comprises a non-backdriveable, right-angle high-torque gearbox.

19. The system of claim 18, wherein the gearbox comprises two stages of gears.

20. The system of claim 19, wherein the gearbox comprises a first planetary gear attached to a motor, a right angle worm gear attached to the planetary gear at the motor, and a second planetary gear attached to the right angle worm gear.

21. A robot system comprising:
a mobile robot;
a robotic arm system attached to the robot; wherein the robotic arm system comprises:
an arm base;
a gripper; and
a cooling device comprising a fan.

22. A robot system comprising:
a mobile robot;
a robotic arm system attached to the robot; wherein the robotic arm system comprises:
an arm base;
a first arm;
a first camera attached to the first arm;
a second arm extending from the first arm; and
a second camera attached to the second arm.

23. The system of claim 22, further comprising a first light attached to the first arm and a second light attached to the second arm.
